(19) United States
(12) Patent Application Publication
(10) Pub. No.: US 2021/0127298 A1
(43) Pub. Date: Apr. 29, 2021

(54) User Plane Entity and Method Therein for Enabling User Plane Data Traffic from Sets of Wireless Devices to Be Handled by Virtual Processing Entities in a Wireless Communications Network

(71) Applicant: Telefonaktiebolaget LM Ericsson (publ), Stockholm (SE)

(72) Inventors: Henrik Harmsen, Göteborg (SE); Trevor Neish, Hisings Backa (SE); Linus Gillander, Kullavik (SE); Anders Henriksson, Hisings Kärra (SE)

(21) Appl. No.: 16/973,849

(22) PCT Filed: Jun. 28, 2018
(86) PCT No.: PCT/EP2018/067408

§ 371 Date: Dec. 10, 2020

(51) Int. Cl. H04W 28/08; H04W 40/28; H04L 12/707

(52) U.S. Cl. CPC H04W 28/0838; H04L 45/24; H04W 40/28

(57) ABSTRACT

A method performed in a user plane entity (900) for enabling user plane data traffic from sets of wireless devices to be handled by virtual processing entities in a wireless communications network (100) is provided. The user plane entity (900) assigns an Internet Protocol, IP, address to each virtual processing entity. Also, the user plane entity (900) establishes, for each set of wireless devices, a primary route associating at least one transport channel carrying user plane data traffic from the set of wireless devices (UE_7, UE_8) with the assigned IP address of the virtual processing entity (VPE #4) that is responsible for handling the user plane data traffic from said set of wireless devices (UE_7, UE_8). Further, the user plane entity (900) establishes, for each set of wireless devices, secondary routes associating the at least one transport channel carrying user plane data traffic from the set of wireless devices (UE_7, UE_8) with one or more of the assigned IP addresses of the virtual processing entities (VPE #1, VPE #2, VPE #3) that are currently not responsible for handling the user plane data traffic from said set of wireless devices, respectively. A user plane entity (900) for enabling user plane data traffic from sets of wireless devices to be handled by virtual processing entities in a wireless communications network (100) is also provided.

### TECHNICAL FIELD

Embodiments herein relate to handling user plane data traffic in a wireless communications network. In particular, embodiments herein relate to a user plane entity and method therein for enabling user plane data traffic from sets of wireless devices to be handled by virtual processing entities, VPEs, in a wireless communications network.

### BACKGROUND

A wireless communications network conventionally comprises radio base stations, also referred to as network nodes, providing radio coverage over at least one respective geographical area forming a so-called cell. Wireless devices, also referred to herein as User Equipments, UEs, mobile stations, and/or wireless terminals, are served in the cells by the respective radio base station. The wireless devices transmit data over an air or radio interface to the radio base stations in uplink, UL, transmissions and the radio base stations transmit data over an air or radio interface to the wireless devices in downlink, DL, transmissions. In today's wireless communications networks a number of different technologies are used, such as, for example, 5G/New Radio (NR), Long Term Evolution (LTE), LTE-Advanced, Wideband Code Division Multiple Access (WCDMA), Global System for Mobile communications/Enhanced Data rate for GSM Evolution (GSM/EDGE), Worldwide Interoperability for Microwave Access (WiMax), or Ultra Mobile Broadband (UMB), just to mention a few possible technologies for wireless communication.

FIG. 1 shows one example of a wireless communication network 100. In the wireless communications network 100, a radio base station 110 serves an N number of wireless devices UE_1, UE_2, . . . , UE_N. The radio base stations in a wireless communications network 100 may be said to form a Radio Access Network, RAN. In the wireless communications network 100, the RAN is supported by a core network. The core network 101 may comprise a number of different network nodes or entities enabling, for example, user plane data traffic from the wireless devices UE_1, UE_2, . . . , UE_N, to reach an Application Server, AS 104, in a Data Network, DN 105, such as, e.g. the Internet. This is indicated by the dashed-dotted arrow in FIG. 1.

In the core network of the wireless communications network 100, the user plane data traffic from the wireless devices UE_1, UE_2, . . . , UE_N, is transmitted in transport channels, such as, e.g. GPRS tunnels, over certain network gateways, such as, e.g. a Serving Gateway, SGW 101, and a Packet Data Network, PDN, Gateway, PGW 102. Optionally, in some wireless communications networks 100, the core network 101 may comprise an Evolved Packet Gateway or User Plane Function, EPG/UPF 103, that may implement at least some the SGW and PGW functionality. This is shown by the dashed area in FIG. 1.

The SGW 101 and the PGW 102 in the core network are usually implemented as scalable systems where processing resources may be added to expand capacity when needed. The payload bearing networks in the SGW 101 is the GTP based S1-U towards the RAN, and the GTP-based S5/S8 towards PGW 102, while the payload bearing networks in the PGW 102 is mainly the S5/S8 GTP-based interfaces towards SGW 101 and the SGi interface towards the DN 104. The IP network interfaces and routing solution on the SGi, S5/S8 and S1-U interfaces may be performed in multiple different ways. However, in order to reach a high performance in the SGW 101 and the PGW 102, some form of load balancing across the hardware resources of the SGW 101 and the PGW 102 is needed. Also, the SGW 101 and the PGW 102 need to be resilient against hardware failures, and therefore some kind of redundancy mechanism, such as, e.g. a so-called “1+1” resilience or a so-called “N-way” resilience for their hardware resources is needed. Furthermore, there are two main functions that are executed on the hardware resources of the SGW 101 and PGW 102, namely, user plane data traffic steering and user plane data payload processing.

FIG. 2 shows an example of a network gateway 201, such as, e.g. a EPG/UPF 103, implementing a redundancy mechanism having a “1+1” resilience among its sets of hardware resources. The hardware resources may, for example, be Printed Circuit Boards, PCBs, or Virtual Machines, VMs, on computing hosts in a cloud system architecture. Therefore, the hardware resources are hereinafter referred to as Virtual Processing Entities, VPEs. As shown by the fully-drawn arrows in FIG. 2, a routing module 202, e.g. a router or switch, conventionally receives and distributes incoming user plane data traffic from wireless devices UE_1, UE_2, . . . , UE_N, to the respective VPE that is responsible for handling the user plane data traffic from the wireless devices UE_1, UE_2, . . . , UE_N.

The “1−1” resilience is implemented by each active VPE, i.e. VPE #1, VPE #2, . . . , VPE #N, being associated with an individual non-active back-up or mirrored VPE, i.e. B #1, B #2, . . . , #BN. The individual non-active back-up or mirrored VPEs, i.e. B #1, B #2, . . . , #BN, will keep an updated copy of the processes running in its corresponding active VPE, i.e. VPE #1, VPE #2, . . . , VPE #N. Thus, once an active VPE fails, such as, e.g. VPE #2, its non-active back-up VPE, i.e. B #2, may relatively seamlessly take over the user plane data traffic that the failed active VPE, e.g. VPE #2, was responsible to handling. In this case, no modification of how the router or switch 202 receives and distributes user plane data traffic from the wireless devices UE_1, UE_2, . . . , UE_N, for which the failed VPE, e.g. VPE #2, was responsible for handling the user plane data traffic from is required. This is indicated by the dashed arrows in FIG. 2. However, a drawback with the “1−1” resilience is that it results in that a lot of hardware resources remain unused or non-operational most of the time.

FIG. 3 shows an example of a network gateway 301, such as, e.g. a EPG/UPF 103, implementing a redundancy mechanism having a “N-way” resilience among its sets of hardware resources. As shown in FIG. 3, a routing module 302, e.g. a router or switch, conventionally receives and distributes incoming user plane data traffic from wireless devices UE_1, UE_2, . . . , UE_N, to the respective VPE that is responsible for handling the user plane data traffic from each respective wireless device UE_1, UE_2, . . . , UE_N. Here, at least one spare non-active VPE, i.e. VPE #S, is used as a back-up for all of the active VPEs, i.e. VPE #1, VPE #2, . . . , VPE #N.

The “N-way” resilience is implemented in that all wireless devices UE_1, UE_2, . . . , UE_N, are divided into different sets or groups of wireless devices. All of the sets of wireless devices are then spread evenly across all active VPEs, i.e. VPE #1, VPE #2, . . . , VPE #N. Hence, these sets of wireless devices may also be referred to herein as “load” or “load index” of the active VPEs. Then, in case one of the active VPEs, e.g. VPE #2, fails, the sets of wireless devices, for which the failed VPE, e.g. VPE #2, was responsible for handling the user plane data traffic from, are moved and spread evenly across all remaining active VPEs, i.e. VPE #1, VPE #3, . . . , VPE #N, and the at least one spare non-active VPE, i.e. VPE #S, which is then activated. The latter ensure that there is enough capacity to take care of the sets of wireless devices of the failed VPE, e.g. VPE #2. This is indicated by the dashed arrow in FIG. 3. However, it should also be noted that each active VPEs, i.e. VPE #1, VPE #2, . . . , VPE #N, may also have some spare capacity reserved for this eventuality in order to each be able to take on the responsibility for the some of the sets of wireless devices of the failed VPE, e.g. VPE #2.

Furthermore, when spreading all of the sets of wireless devices evenly across all active VPEs, i.e. VPE #1, VPE #2, . . . , VPE #N, the network gateway 301 may also employ a traffic steering function which keeps track of in which active VPE, i.e. VPE #1, VPE #2, . . . , VPE #N, each set of wireless devices reside. Hence, if one or more sets of wireless devices are moved due to a VPE failure, the traffic steering of the traffic steering function is updated accordingly. The traffic steering function enable incoming user plane data traffic of the sets of wireless devices of the failed VPE, e.g. VPE #2, to be forwarded or re-routed via the remaining active and possibly spare VPEs, i.e. VPE #1, VPE #3, . . . , VPE #N, VPE #S, to the one of the remaining active and possibly spare VPEs, i.e. VPE #1, VPE #3, . . . , VPE #N, VPE #S, which is now responsible for the corresponding set of wireless devices of the failed VPE, e.g. VPE #2. This is because the incoming user plane data traffic of the sets of wireless devices of the failed VPE, e.g. VPE #2, will be spread evenly across the remaining active and possibly spare VPEs, i.e. VPE #1, VPE #3, . . . , VPE #N, VPE #S, e.g. by using an Equal-Cost Multi-Path, ECMP, routing protocol. This combination of “N-way resilience” and a traffic steering function enables an even load on remaining active and possibly spare VPEs, i.e. VPE #1, VPE #3, . . . , VPE #N, VPE #S, after the removal or failure of a VPE. This is also true in case of scale up, i.e. adding additional VPEs, for that matter. Hence, it is more hardware resources efficient than, for example, implementing only a “1+1” resilience.

However, there is a constantly increased demand for improved resilience and effectivity when it comes to handling failure, removal or addition of VPEs in future wireless communications networks. Hence, there is also a need to improve the handling of user plane data traffic from sets of wireless devices by VPEs in a wireless communications network.

### SUMMARY

It is an object of embodiments herein to improve the handling of user plane data traffic from sets of wireless devices by virtual processing entities in a wireless communications network.

According to a first aspect of embodiments herein, the object is achieved by a method performed in a user plane entity for enabling user plane data traffic from sets of wireless devices to be handled by virtual processing entities in a wireless communications network. The user plane entity assigns an IP address to each virtual processing entity. Also, the user plane entity establishes, for each set of wireless devices, a primary route associating at least one transport channel carrying user plane data traffic from the set of wireless devices with the assigned IP address of the virtual processing entity that is responsible for handling the user plane data traffic from said set of wireless devices. Further, the user plane entity establishes, for each set of wireless devices, secondary routes associating the at least one transport channel carrying user plane data traffic from the set of wireless devices with one or more of the assigned IP addresses of the virtual processing entities that are currently not responsible for handling the user plane data traffic from said set of wireless devices, respectively.

According to a second aspect of embodiments herein, the object is achieved by a user plane entity for enabling user plane data traffic from sets of wireless devices to be handled by virtual processing entities in a wireless communications network. The user plane entity is configured to assign an IP address to each virtual processing entity. The user plane entity is also configured to establish, for each set of wireless devices, a primary route associating at least one transport channel carrying user plane data traffic from the set of wireless devices with the assigned IP address of the virtual processing entity that is responsible for handling the user plane data traffic from said set of wireless devices. Further, the user plane entity is configured to establish, for each set of wireless devices, secondary routes associating the at least one transport channel carrying user plane data traffic from the set of wireless devices with one or more of the assigned IP addresses of the virtual processing entities that are currently not responsible for handling the user plane data traffic from said set of wireless devices, respectively.

According to a third aspect of the embodiments herein, a computer program is also provided configured to perform the method described above. Further, according to a fourth aspect of the embodiments herein, carriers are also provided configured to carry the computer program configured for performing the method described above.

By assigning an IP address to each VPE and establishing a primary route and secondary routes, e.g. in a routing table, associating the transport channels of the sets of wireless devices, e.g. GPRS tunnels, with the assigned IP addresses of the VPEs, the user plane data traffic in-between the remaining VPEs after a VPE failure will progressively reside or be reduced because, as wireless devices in the sets of wireless devices of the failed VPE subsequently will re-attach in the wireless communications network, those wireless devices will get a new IP address associated with their transport channel that will route their user plane data traffic directly to the VPE that has taken over the responsibility for handling the user plane data traffic from those wireless devices. This will advantageously decrease the Input/Output, I/O, load on the interfaces of the VPEs, since less and less user plane data traffic will need to be re-routed between the VPEs. Hence, the handling of user plane data traffic from sets of wireless devices by virtual processing entities associated with a network gateway in a wireless communications network is improved.

### BRIEF DESCRIPTION OF THE DRAWINGS

Features and advantages of the embodiments will become readily apparent to those skilled in the art by the following detailed description of exemplary embodiments thereof with reference to the accompanying drawings, wherein:

FIG. 1 is a schematic block diagram illustrating a wireless communications network,

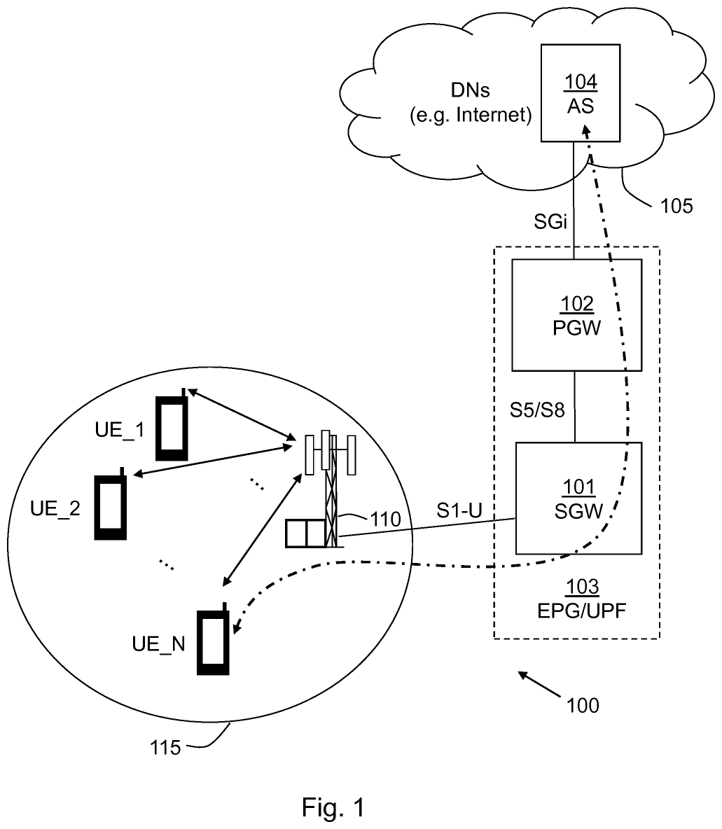

FIG. 2 is a schematic block diagram illustrating a network gateway implementing “1+1” resilience,

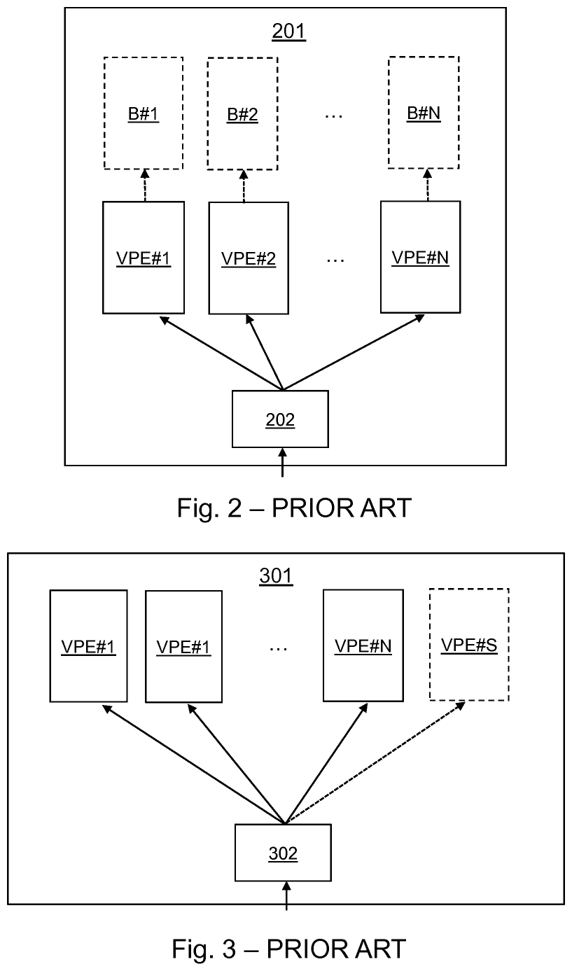

FIG. 3 is a schematic block diagram illustrating a network gateway implementing “N-way” resilience,

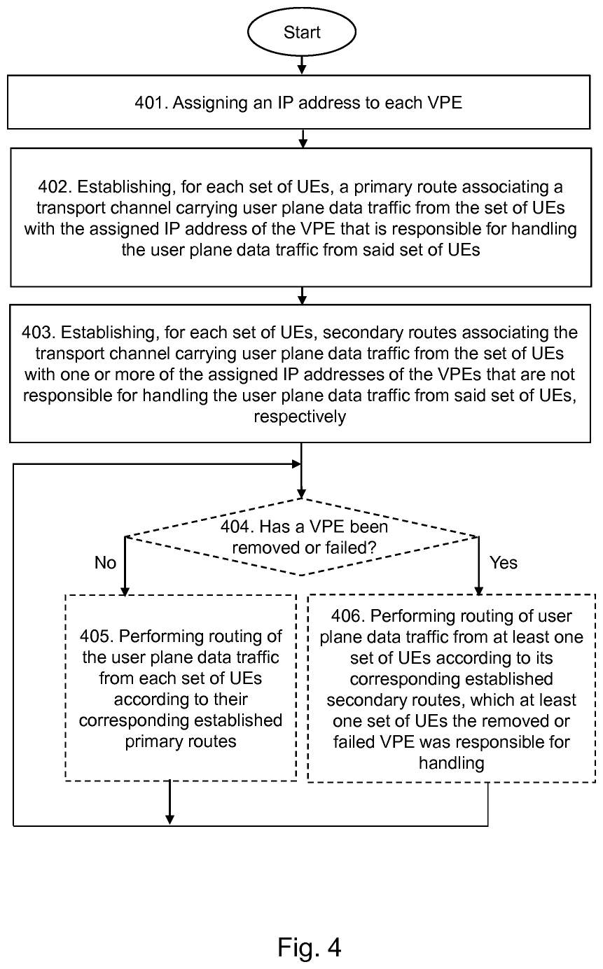

FIG. 4 is a flowchart depicting embodiments of a method in a user plane entity,

FIGS. 5-8 are schematic block diagram illustrating embodiments of a user plane entity in a wireless communications network,

FIG. 9 is a block diagram depicting embodiments of a user plane entity.

### DETAILED DESCRIPTION

The figures are schematic and simplified for clarity, and they merely show details which are essential to the understanding of the embodiments presented herein, while other details have been left out. Throughout, the same reference numerals are used for identical or corresponding parts or steps.

As part of the developing of the embodiments described herein, it has been realized that the combination of “N-way resilience” and a traffic steering function is still not a fully efficient solution since there will be a lot of user plane data traffic in-between the remaining active and possibly spare VPEs, i.e. VPE #1, VPE #3, . . . , VPE #N, VPE #S, when the traffic steering function forwards incoming user plane data traffic of the sets of wireless device of the failed VPE, e.g. VPE #2. Hence, there is a need to provide a more efficient solution which reduces the user plane data traffic in-between the remaining active and possibly spare VPEs, i.e. VPE #1, VPE #3, . . . , VPE #N, VPE #S.

In other words, the problems with existing solutions, such as, e.g. the combination of “N-way resilience” and a traffic steering function, is that most of the incoming user plane data traffic of the sets of wireless devices of the failed VPE will first be handled by the traffic steering function in the “wrong” VPE. This is because the incoming user plane data traffic of the sets of wireless devices of the failed VPE will be evenly spread across the remaining VPEs and only some parts of the incoming user plane data traffic of the sets of wireless devices may end up directly at the VPE now responsible for handling the incoming user plane data traffic. This means that the rest of the incoming user plane data traffic of the wireless devices in those sets of wireless devices must jump, i.e. be re-routed, to the VPE has taken over the responsibility for handling the user plane data traffic from each particular wireless device in those sets of wireless devices, i.e. it must re-routed to the VPE currently hosting the wireless device. This extra jump costs hardware resources, since it puts an extra load on the I/O interface of the hardware resources. Since there are solutions with “N-way resilience” and a traffic steering function, such as, e.g. a virtual EPG, vEPG, which already has a combined traffic steering and processing part for wireless devices, it would be advantageous if it was possible to save a jump by making sure that the incoming user plane data traffic of the sets of wireless devices of the failed VPE is directly routed to the correct VPE that has taken over the responsibility for handling that user plane data traffic. This would provide a so-called ingress optimization, i.e. an optimization of the routing of incoming user plane data traffic.

This issue is addressed by the embodiments herein by first having a user plane entity assigning one IP address per VPE and use routing to guide traffic directly to those VPEs, and secondly announcing secondary routes for the same destination, but which has lower priority and one or more other VPEs being so-called next-hops. This means that in case of failure, the secondary routes of the sets of wireless devices of the failed VPE will spread the user plane data traffic from these sets of wireless devices over one or more other VPEs, e.g. over all remaining active VPEs. Since the responsibility of the sets of wireless devices of the failed VPE also will be spread across the remaining VPEs, there will initially be some re-routing of the sessions of the moved wireless devices in the sets of wireless devices between the remaining VPEs. However, when the wireless devices in the sets of wireless devices of the failed VPE eventually re-attach in the wireless communications network, these wireless devices will get a new IP address for their transport channel, e.g. a new GTP IP address, and thus will regain ingress optimization. In fact, if the user data plane traffic performance is limited by the I/O resources of the VPEs, it may be shown that the total user data plane traffic performance is (up to) doubled after deploying the ingress optimization according to the embodiments of the user plane entity described herein. In addition, another advantage of the embodiments described herein is that they will also enable an easy scale-up or scale-down of the number of VPEs employed by a network gateway in the wireless communications network.

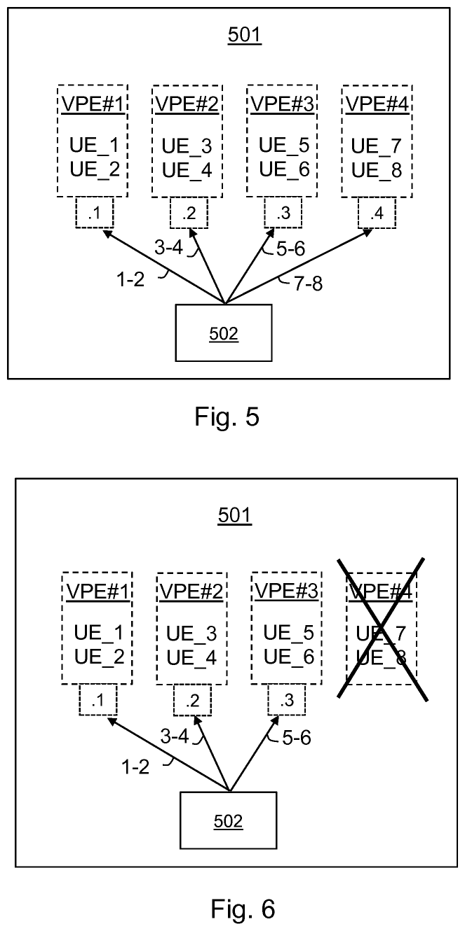

Embodiments of the user plane entity and a method therein will be described in more detail below with reference to FIGS. 4-9.

Example of embodiments of a method performed in a user plane entity 900 for enabling user plane data traffic from sets of wireless devices, UEs, to be handled by virtual processing entities, VPEs, in a wireless communications network 100 will now be described with reference to the flowchart depicted in FIG. 4. FIG. 4 is an illustrated example of actions or operations which may be taken by a user plane entity 900 in the wireless communication network 100. The method may comprise the following actions.

Action 401

The user plane entity 900 assigns an Internet Protocol, IP, address to each virtual processing entity, VPE. This means, for example, that the user plane entity 900 may assign one GTP IP address per VPE. Here, it should also be noted that the term “each VPE” may refer to any number of VPEs of the VPEs available to handle user plane data traffic in the wireless communications network 100, i.e. each VPE may refer to any subset of available VPEs. In some embodiments, the virtual processing entities, VPEs, may be Virtual Machines, VMs, pods or containers operating on data processing resources associated with a network gateway in the wireless communications network 100. This means that the VPEs may be run or operated on hardware resources, such as, for example, Printed Circuit Boards, PCBs, and/or on computing hosts operating Virtual Machines, VMs, in a cloud system architecture. The network gateway may, for example, be a SGW/PGW, an Evolved Packet Gateway, EPG, or a User Plane Function, UPF, which utilizes hardware resources and/or external computing hosts for handling the user plane data traffic of the wireless devices in the wireless communications network 100.

Action 402

After the assigning in Action 401, the user plane entity 900 establishes, for each set of wireless devices, a primary route associating at least one transport channel carrying user plane data traffic from the set of wireless devices with the assigned IP address of the virtual processing entity that is responsible for handling the user plane data traffic from said set of wireless devices. This means that the user plane entity 900 may, for example, set up primary routes for user plane data traffic from each set of wireless devices that guides the respective user plane data traffic directly to the VPE that is responsible for handling the user plane data traffic from each respective set of wireless devices. In other words, this means that all wireless devices being handled by a certain VPE will get that VPEs assigned IP address for their transport channel, e.g. a GTP tunnel. The primary routes may, for example, be set up in routing table associating the GTP tunnel interfaces of the sets of wireless devices with the assigned IP address of the VPE responsible for handling the user plane data traffic from each corresponding set of wireless devices.

In some embodiments, the responsibility for processing user plane data traffic from the sets of wireless devices is shared evenly amongst the virtual processing entities, VPEs. This may, for example, mean that the user plane entity 900 may group the wireless devices in the wireless communications network 100 into different set of wireless devices and spread the sets of wireless devices evenly across all of the VPEs such that the load, or load index, is substantially similar for all VPEs. Accordingly, in some embodiments, any even sharing of the responsibility for processing user plane data traffic from sets of wireless devices may be performed in an N-way resilient manner.

In some embodiments, the transport channel carrying user plane data traffic from each set of wireless devices may comprise one or more GPRS Tunneling Protocol, GTP, tunnels. This means, for example, that the transport channel may be a GTP tunnel that is set up between a network node 110 and a network gateway, e.g. a SGW/PGW, an Evolved Packet Gateway, EPG, or a User Plane Function, UPF, in the wireless communications network 110 for the user plane data traffic from the sets of wireless devices. According to one example, such GTP tunnels may be established over the S1-U interface between the network node 110 in the RAN and the SGW 101 in the core network of the wireless communications network 100.

Action 403

Furthermore, the user plane entity 900 establishes, for each set of wireless devices, secondary routes associating the at least one transport channel carrying user plane data traffic from the set of wireless devices with one or more of the assigned IP addresses of the virtual processing entities that are currently not responsible for handling the user plane data traffic from said set of wireless devices, respectively. This means that the user plane entity 900 may, for example, set up secondary routes for user plane data traffic from each set of wireless devices that, if invoked, will spread the respective user plane data traffic to one or more other VPEs that are not responsible for handling the user plane data traffic from that respective set of wireless devices initially. In other words, this means, for example, that all sets of wireless devices being handled by a first VPE may get secondary routes that associates their transport channels with the assigned IP addresses for the other VPEs, i.e. other than the first VPE. The secondary routes may, for example, be set up in a similar manner as the primary routes in the same routing table.

In some embodiments, each of the established primary routes are prioritized higher than the established secondary routes in the routing performed by the user plane entity 900. This means that the secondary routes of a set of wireless devices will only be used in case the primary route for that set of wireless devices fails or goes down. It should here be noted that the higher priority may be implicitly indicated via the IP address, for example, by having a longer prefix, such as, e.g. more bits in a subnet mask.

Action 404

Optionally, after establishing the primary and secondary routes according to

Actions 402-403, the user plane entity 900 may determine that one or more of the virtual processing entities has been removed or failed. In this case, the user plane entity 900 may proceed to Action 406. However, in case the user plane entity 900 determines that no virtual processing entities, VPEs, has been removed or failed, then the user plane entity 900 may proceed to Action 405.

Action 405

In case the user plane entity 900 determined that no VPE has been removed or failed in Action 404, the user plane entity 900 may perform routing of the user plane data traffic from each set of wireless devices according to their corresponding established primary routes. This means that all user plane data traffic from each set of wireless devices will be guided directly to the VPE that is responsible for handling the user plane data traffic from each corresponding set of wireless devices. This state may be referred to as ingress optimized state.

Action 406

In case the user plane entity 900 determined that one or more of the VPEs has been removed or failed in Action 404, the user plane entity 900 may perform routing of user plane data traffic from at least one set of wireless devices according to its corresponding established secondary routes, which at least one set of wireless device the removed or failed one or more virtual processing entities was responsible for handling. This means, for example, that user plane data traffic from the sets of wireless devices that was handled by the removed or failed VPEs may be distributed to and across the remaining VPEs still operative. Also, in some embodiments, the user plane data traffic from the at least one set of wireless devices may be spread evenly across the rest of the assigned IP addresses of the virtual processing entities indicated by corresponding established secondary routes. This means, for example, that the user plane data traffic from the sets of wireless devices that was handled by the removed or failed VPEs, may be distributed fairly across the remaining VPEs still operative. In this case, according to some embodiments, the user plane data traffic from the at least one set of wireless devices may be spread evenly in accordance with an Equal-Cost Multi-Path, ECMP, routing protocol.

In some embodiments, the responsibility for processing user plane data traffic from the at least one set of wireless devices may be shared evenly amongst the remaining virtual processing entities. This means that, in case one or more of VPEs is removed or fails, the sets of wireless devices handled by the removed or failed VPEs may be moved to the remaining VPEs still operative. It also means that the redistribution of the sets of wireless devices to the remaining VPEs may be performed such that the load, or load index, is substantially similar for all remaining VPEs.

By redistributing the sets of wireless devices of the removed or failed VPE over the remaining VPEs, and distributing their user data plane traffic across the remaining VPEs, there will initially be some user plane data traffic being re-routed between VPEs; that is, some user plane data traffic being received in one VPE will be re-routed to the correct VPE that is currently responsible for handling that particular user plane data traffic. However, when the wireless devices in the sets of wireless devices of the removed or failed VPE eventually re-attach in the wireless communications network 100, these wireless devices will get a new IP address for their transport channel, e.g. a new GTP IP address, and thus will regain ingress optimization.

In some embodiments, the user plane entity 900 may force a change of transport channel for one or more wireless device in at least one set of wireless devices. This means that the user plane entity 900 may initiate a detach procedure for one or more wireless devices in at least one set of wireless devices in order to force the one or more wireless devices to perform a re-attachment procedure in the wireless communications network 100 and thus receive a new IP address for their transport channel in the network gateway.

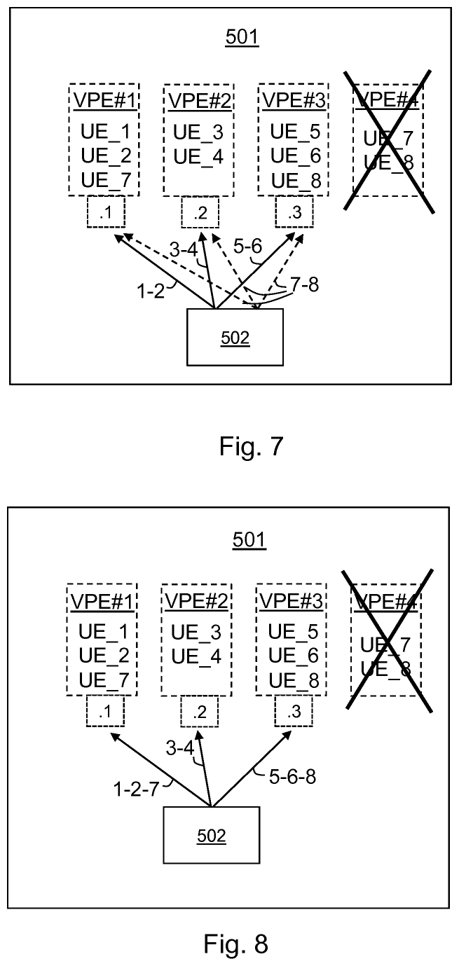

FIGS. 5-8 shows an illustrative example of how embodiments of the user plane entity 900 may operate in a wireless communications network 100. The user plane entity 900 may be implemented as a separate entity located outside of the network gateway 501, or provided as a service from a remote data processing network, that is capable of communicating with the network gateway 501 and/or the routing module 502 therein. The user plane entity 900 may also form a part of the network gateway 501 and/or the routing module 502.

In FIG. 5, the network gateway 501 is currently shown employing four active VPEs, i.e. VPE #1, VPE #2, VPE #3, and VPE #4, for handling user plane data traffic from sets of wireless devices, i.e. (UE_1, UE_2), (UE_3, UE_4), (UE_5, UE_6), (UE_7, UE_8). For the sake of simplicity and illustrative purposes, each of the sets of wireless devices here comprises only two wireless devices, and each VPE is shown as responsible for handling only a single set of wireless devices. However, as is readily understood, the number of wireless devices in each set of wireless devices and the number of sets of wireless devices handled by each VPE are conventionally significantly larger. Also, the number of VPEs employed by the network gateway 501 may also be any suitable number of VPEs.

In FIG. 5, it also illustrated how the user plane entity 900 has assigned an individual GTP IP address to each of the four active VPEs; that is, VPE #1 has been assigned the GTP IP address “.1”, VPE #2 has been assigned the GTP IP address “.2”, VPE #3 has been assigned the GTP IP address “.3”, and VPE #4 has been assigned the GTP IP address “.4”. It should be noted that the GTP IP addresses are here indicated only by their significant differentiating IP address part, and not the full IP address. Via the fully drawn arrows, it is also illustrated how the user plane entity 900 route the user plane data traffic from each set of wireless devices according to their corresponding established primary routes; that is, for example, user plane data traffic from the set of wireless devices (UE_1, UE_2) is directly routed to the GTP IP address “.1” of the VPE #1 which is responsible for handling the user plane data traffic from the wireless devices, UE_1 and UE_2, in the set of wireless devices (UE_1, UE_2). Similarly, user plane data traffic from the sets of wireless devices (UE_3, UE_4), (UE_5, UE_6), and (UE_7, UE_8), are directly routed to the GTP IP address “.2” of the VPE #2, “.3” of the VPE #3, and “.4” of the VPE #4, respectively, which are responsible for handling the user plane data traffic from the wireless devices, UE_3 and UE_4, UE_5 and UE_6, and UE_7 and UE_8, respectively, in the corresponding set of wireless devices (UE_3, UE_4), (UE_5, UE_6) and (UE_7, UE_8). It should be noted that no back-up or spare VPE is required to be implemented for the network gateway 501.

FIG. 6 illustrates a removal or failure of the VPE #4 for the network gateway 501 in FIG. 5. This means that the user plane entity 900 is no longer able to route the user plane data traffic from the wireless devices, UE_7 and UE_8, in the set of wireless devices (UE_7, UE_8) directly to the VPE #4.

FIG. 7 illustrates how the user plane entity 900 may move the responsibility for handling the user plane data traffic from the wireless devices, UE_7 and UE_8, in the set of wireless devices (UE_7, UE_8) from the removed or failed VPE #4 over to one or more of the remaining still operative VPEs, e.g. VPE #1 and VPE #3. It should be noted that the move of the responsibility may be performed by the user plane entity 900 in a N-way resilient manner across the remaining still operative VPEs, i.e. VPE #1, VPE #2 and VPE #3.

In FIG. 7, it also illustrated how the user plane entity 900, upon detecting the failure of VPE #4, will route the user plane data traffic from the set of wireless devices (UE_7, UE_8) according to its corresponding established secondary routes. This means that the user plane data traffic from the wireless devices, UE_7 and UE_8, in the set of wireless devices (UE_7, UE_8) will be distributed and routed to the GTP IP address “.1” of the VPE #1, the GTP IP address “.2” of the VPE #2, and the GTP IP address “.3” of the VPE #3, as illustrated by the dashed arrows in FIG. 7. The distribution of the user plane data traffic from the wireless devices, UE_7 and UE_8, in the set of wireless devices (UE_7, UE_8) may be performed by the user plane entity 900 in accordance with an Equal-Cost Multi-Path, ECMP, routing protocol. As may also be seen in FIG. 7, if, for example, the user plane data traffic of the wireless device UE 7 after the failure of VPE #4 is directed to VPE #2 or VPE #3, i.e. any other VPE than VPE #1 which currently is responsible for handling the user plane data traffic of the wireless device UE 7, the traffic steering function associated with the network gateway 501 will re-route this user plane data traffic from the VPE #2 or VPE #3 to the VPE #1.

FIG. 8 illustrates how the user plane data traffic from the wireless devices, UE_7 and UE_8, in the set of wireless devices (UE_7, UE_8) will obtain a new GTP IP address for its transport channel after performing a re-attachment procedure in the wireless communications network after the VPE #4 was removed or failed. This means, for example, that since the user plane data traffic from the wireless devices UE_7 after the re-attachment procedure will obtain the GTP IP address “.1” of the VPE #1 for its transport channel, i.e. as its primary route, the user plane data traffic from the wireless devices UE_7 will be again be directly routed to the VPE responsible for handling its user plane data traffic, i.e. VPE #1. Thus, the user plane data traffic from the wireless devices UE_7 will regain ingress optimization. The same applies to the user plane data traffic from the wireless devices UE_8 after the wireless devices UE_8 performs a re-attachment procedure.

Furthermore, according to another aspect, it may also be noted that there may be one level of recursion in directing user plane data traffic to a correct VPE. First, the GTP network identifier, and secondly, the IP routing to get to the IP address part of the GTP network identifier. The GTP network identifier for the network gateway 501 may be an IP address+tunnel ID. The user plane entity 900 may select the GTP network identifier for a set of wireless devices, so that the IP address part is a “virtual” address, i.e. it is not associated with any specific VPE. Then, the user plane entity 900 may announce reachability, i.e. a ‘route’ in the traditional IP-routing sense, for a virtual IP address saying that the virtual IP address may be reached by sending user plane data traffic to the IP address network identifier of the VPE that the wireless devices are currently processed on. Thus, a “primary” route may here be selecting a virtual IP address as part of the GTP network identifier of the wireless device, and announcing via traditional IP routing methods the reachability for the virtual IP address via the assigned IP address, e.g. interface IP address, of the VPE. Further, for the “secondary” routes, since there is only one GTP network identifier for a wireless device at a time and a set of wireless devices may have the same IP address part, but must each have a unique tunnel ID part for a given GTP interface on the network gateway 501, the “secondary” routes may announces reachability for a wider or larger, e.g. more than one, set of virtual IP addresses via all the network identifiers of all the VPEs that make up the GTP interface of the network gateway 501.

During a transient state, such as, for example, as shown in FIG. 7, when secondary routes are evoked for one or more VIPs, new GTP network identifiers will be given such that the virtual IP address part is reachable via the same VPE where the wireless device is processed, for example, UE_7 will get a virtual IP address with a route next-hop “.1”. It should also be noted that the duration of the transient state is dependent on whether the user plane entity 900 tries to initiate or force a change of GTP network identifiers, or if the user plane entity 900 does nothing and waits for the effected wireless devices to be removed and added again as part of the natural course of behaviour of wireless devices.

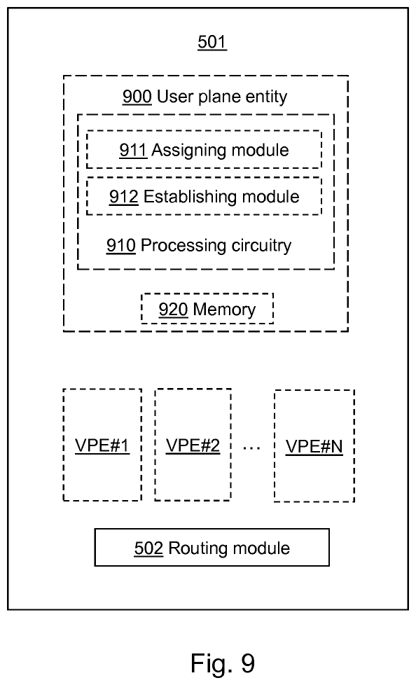

To perform the method actions in the user plane entity 900 for enabling user plane data traffic from sets of wireless devices to be handled by virtual processing entities in a wireless communications network 100, the user plane entity 900 may comprise the following arrangement depicted in FIG. 9. FIG. 9 shows a schematic block diagram of embodiments of a user plane entity 900 when implemented in a network gateway 501, such as, e.g. a EPG/UPF. The embodiments of the user plane entity 900 described herein may be considered as independent embodiments or may be considered in any combination with the network gateway 501 to describe non-limiting examples of the embodiments described herein. It should also be noted that the user plane entity 900 may further be implemented as a separate entity located outside of the network gateway 501, or provided as a service in a remote data processing network, that is capable of communicating with the network gateway 501 and/or the routing module 502 therein. Here, the routing module 502 in the network gateway 501 may be a standard IP router.

The user plane entity 900 may comprise processing circuitry 910 and a memory 920. The processing circuitry 910 may also comprise an assigning module 911 and a establishing module 912. It should also be noted that some or all of the functionality described in the embodiments above as being performed by the user plane entity 900 may be provided by the processing circuitry 910 executing instructions stored on a computer-readable medium, such as, e.g. the memory 920 shown in FIG. 9.

The user plane entity 900 or processing circuitry 910 is configured to, or may comprise the assigning module 911 configured to, assign an IP address to each virtual processing entity. Also, the user plane entity 900 or processing circuitry 910 is configured to, or may comprise the establishing module 912 configured to, establish, for each set of wireless devices, a primary route associating at least one transport channel carrying user plane data traffic from the set of wireless devices with the assigned IP address of the virtual processing entity that is responsible for handling the user plane data traffic from said set of wireless devices. Further, the user plane entity 900 or processing circuitry 910 is configured to, or may comprise the establishing module 912 configured to, establish, for each set of wireless devices, secondary routes associating the at least one transport channel carrying user plane data traffic from the set of wireless devices with one or more of the assigned IP addresses of the virtual processing entities that are currently not responsible for handling the user plane data traffic from said set of wireless devices, respectively.

In some embodiments, each of the established primary routes are prioritized higher than the established secondary routes in the routing performed by the user plane entity 900. Also, in some embodiments, the responsibility for processing user plane data traffic from the sets of wireless devices may be shared evenly amongst the virtual processing entities.

According to some embodiments, the user plane entity 900 or processing circuitry 910 may be configured to perform routing of the user plane data traffic from each set of wireless devices according to their corresponding established primary routes.

Also, in some embodiments, the user plane entity 900 or processing circuitry 910 may be configured to determine that one or more of the virtual processing entities has been removed or failed, and, if so, perform routing of user plane data traffic from at least one set of wireless devices according to its corresponding established secondary routes, which at least one set of wireless device the removed or failed one or more virtual processing entities was responsible for handling. In this case, according to some embodiments, the responsibility for processing user plane data traffic from the at least one set of wireless devices may be shared evenly amongst the remaining virtual processing entities. Further, the user plane data traffic from the at least one set of wireless devices may be spread evenly across the rest of the assigned IP addresses of the virtual processing entities indicated by corresponding established secondary routes. In this case, the user plane data traffic from the at least one set of wireless devices may be is spread evenly in accordance with an Equal-Cost Multi-Path, ECMP, routing protocol.

According to some embodiments, the user plane entity 900 or processing circuitry 910 may be configured to force a change of transport channel for one or more wireless device in at least one set of wireless devices. According to some embodiments, any even sharing of the responsibility for processing user plane data traffic from sets of wireless devices may be performed in an N-way resilient manner.

In some embodiments, the transport channel carrying user plane data traffic from each set of wireless devices comprise one or more GPRS Tunneling Protocol, GTP, tunnels. In some embodiments, the virtual processing entities are Virtual Machines, VMs, pods or containers operating on data processing resources associated with the network gateway 501 in the wireless communications network 100.

It should be noted that when the user plane entity 900 is described as performing routing of the user plane data traffic from each set of wireless devices, this may be performed in co-operation with the routing module 502. The user plane entity 900 and the routing module 502, as described above, may operate and function as a so-called stateful traffic steering function for the network gateway 501, e.g. an SGW/PGW, EPG or UPF, which achieves a minimal I/O load for the user plane data traffic on transport channel interfaces, e.g. GTP interfaces.

Furthermore, the embodiments for enabling user plane data traffic from sets of wireless devices, UEs, to be handled by virtual processing entities, VPEs, associated with a network gateway 301 in a wireless communications network 100 described above may be implemented through one or more processing circuitry, such as the processing circuitry 910 in the user plane entity 900 depicted in FIG. 5, together with computer program code for performing the functions and actions of the embodiments herein. The program code mentioned above may also be provided as a computer program product, for instance in the form of a data carrier carrying computer program code or code means for performing the embodiments herein when being loaded into the processing circuitry 910 in the user plane entity 900. The computer program code may e.g. be provided as pure program code in the user plane entity 900 or on a server and downloaded to the user plane entity 900. Thus, it should be noted that the modules of the user plane entity 900 may in some embodiments be implemented as computer programs stored in memory, e.g. in the memory modules 920 in FIG. 9, for execution by processors or processing modules, e.g. the processing circuitry 910 of FIG. 9.

Those skilled in the art will also appreciate that the processing circuitry 510 and the memory 920 described above may refer to a combination of analog and digital circuits, and/or one or more processors configured with software and/or firmware, e.g. stored in a memory, that when executed by the one or more processors such as the processing circuitry 920 perform as described above. One or more of these processors, as well as the other digital hardware, may be comprised in a single application-specific integrated circuit (ASIC), or several processors and various digital hardware may be distributed among several separate components, whether individually packaged or assembled into a system-on-a-chip (SoC).

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

It should also be noted that the various example embodiments described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The embodiments herein are not limited to the above described preferred embodiments. Various alternatives, modifications and equivalents may be used. Therefore, the above embodiments should not be construed as limiting.

### ABBREVIATIONS

IP Internet Protocol,

GPRS General Packet Radio Services

GTP GPRS Tunneling Protocol

ECMP Equal-Cost Multi-Path

VM Virtual Machine

VPE Virtual Processing Entities

RAN Radio Access Network

SGW Serving Gateway

PDN Packet Data Network

PGW PDN Gateway

EPG Evolved Packet Gateway

AS Application Server

DN Data Network

PCB Printed Circuit Board

1-27. (canceled)

28. A method, performed in a user plane entity, for enabling user plane data traffic from sets of wireless devices to be handled by virtual processing entities in a wireless communications network, the method comprising:
assigning an Internet Protocol (IP) address to each virtual processing entity;
establishing, for each set of wireless devices, a primary route associating at least one transport channel carrying user plane data traffic from the set of wireless devices with the assigned IP address of the virtual processing entity that is responsible for handling the user plane data traffic from the set of wireless devices; and
establishing, for each set of wireless devices, secondary routes associating the at least one transport channel carrying user plane data traffic from the set of wireless devices with one or more of the assigned IP addresses of the virtual processing entities that are currently not responsible for handling the user plane data traffic from the set of wireless devices, respectively.

29. The method of claim 28, wherein each of the established primary routes are prioritized higher than the established secondary routes in the routing performed by the user plane entity.

30. The method of claim 28, wherein responsibility for processing user plane data traffic from the sets of wireless devices is shared evenly amongst the virtual processing entities.

31. The method of claim 28, further comprising performing routing of the user plane data traffic from each set of wireless devices according to their corresponding established primary routes.

32. The method of claim 28, further comprising
determining that one or more of the virtual processing entities has been removed or failed; and
in response to the determining, performing routing of user plane data traffic from at least one set of wireless devices according to its corresponding established secondary routes, which at least one set of wireless devices the removed or failed one or more virtual processing entities was responsible for handling.

33. The method of claim 32, wherein responsibility for processing user plane data traffic from the at least one set of wireless devices is shared evenly amongst remaining virtual processing entities.

34. The method of claim 32, wherein the user plane data traffic from the at least one set of wireless devices is spread evenly across the rest of the assigned IP addresses of the virtual processing entities indicated by corresponding established secondary routes.

35. The method of claim 34, wherein the user plane data traffic from the at least one set of wireless devices is spread evenly in accordance with an Equal-Cost Multi-Path (ECMP) routing protocol.

36. The method of claim 28, further comprising forcing a change of transport channel for one or more wireless device in at least one set of wireless devices.

37. The method of claim 28, wherein any even sharing of the responsibility for processing user plane data traffic from the sets of wireless devices is performed in an N-way resilient manner.

38. A user plane entity for enabling user plane data traffic from sets of wireless devices to be handled by virtual processing entities in a wireless communications network, the user plane entity comprising:
processing circuitry;
memory containing instructions executable by the processing circuitry whereby the user plane entity is operative to:
assign an Internet Protocol (IP) address to each virtual processing entity;
establish, for each set of wireless devices, a primary route associating at least one transport channel carrying user plane data traffic from the set of wireless devices with the assigned IP address of the virtual processing entity that is responsible for handling the user plane data traffic from the set of wireless devices; and
establish, for each set of wireless devices, secondary routes associating the at least one transport channel carrying user plane data traffic from the set of wireless devices with one or more of the assigned IP addresses of the virtual processing entities that are currently not responsible for handling the user plane data traffic from the set of wireless devices, respectively.

39. The user plane entity of claim 38, wherein the instructions are such that the user plane entity is operative to prioritize each of the established primary routes higher than the established secondary routes in the routing performed by the user plane entity.

40. The user plane entity of claim 38, wherein the instructions are such that the user plane entity is operative to cause responsibility for processing user plane data traffic from the sets of wireless devices to be shared evenly amongst the virtual processing entities.

41. The user plane entity of claim 38, wherein the instructions are such that the user plane entity is operative to perform routing of the user plane data traffic from each set of wireless devices according to their corresponding established primary routes.

42. The user plane entity of claim 38, wherein the instructions are such that the user plane entity is operative to:
determine that one or more of the virtual processing entities has been removed or failed; and
in response to the determining, perform routing of user plane data traffic from at least one set of wireless devices according to its corresponding established secondary routes, which at least one set of wireless device the removed or failed one or more virtual processing entities was responsible for handling.

43. The user plane entity of claim 42, wherein the instructions are such that the user plane entity is operative to cause responsibility for processing user plane data traffic from the at least one set of wireless devices to be shared evenly amongst remaining virtual processing entities.

44. The user plane entity of claim 42, wherein the instructions are such that the user plane entity is operative to cause the user plane data traffic from the at least one set of wireless devices to be spread evenly across the rest of the assigned IP addresses of the virtual processing entities indicated by corresponding established secondary routes.

45. The user plane entity of claim 44, wherein the user plane data traffic from the at least one set of wireless devices is spread evenly in accordance with an Equal-Cost Multi-Path (ECMP) routing protocol.

46. The user plane entity of claim 38, wherein the instructions are such that the user plane entity is operative to force a change of transport channel for one or more wireless device in at least one set of wireless devices.

47. The user plane entity of claim 38, wherein any even sharing of the responsibility for processing user plane data traffic from the sets of wireless devices is performed in an N-way resilient manner.
